(19) United States
(12) Patent Application Publication
(10) Pub. No.: US 2024/0369972 A1
(43) Pub. Date: Nov. 7, 2024

(54) METHOD FOR MANUFACTURING A TIMEPIECE COMPONENT

(71) Applicant: ROLEX SA, Geneva (CH)

(72) Inventors: Florian Calame, Epalinges (CH); Xavier Multone, Lausanne (CH)

(73) Assignee: ROLEX SA, Geneva (CH)

(21) Appl. No.: 18/293,499

(22) PCT Filed: Jul. 28, 2022
(86) PCT No.: PCT/EP2022/071254

§ 371 Date: Jan. 30, 2024

(30) Foreign Application Priority Data
Aug. 2, 2021 (EP) 21189052.0

(51) Int. Cl. G04B 19/04

(52) U.S. Cl. CPC G04B 19/042

(57) ABSTRACT

The method for manufacturing a mold for manufacturing a timepiece component includes producing (E1) a recess originating from an upper surface (21) of a substrate (20), so as to form a recess (30) delimited by at least one surface (31) inclined relative to the plane (P1) in which the upper surface (21) of the substrate (20) extends, and producing (E3) at least one wall (41) of the mold comprising depositing (E31) a material on at least part of the surfaces of the substrate (20), optionally covered with a conductive layer and/or an anti-reflective layer (25), so as to form a mold at least partially delimited by at least one wall (41) of the material and by the at least one inclined surface (31) of the recess (30), and optionally by at least part of the upper surface (21) of the substrate (20).

The present invention relates to a method for manufacturing a mold for manufacturing a timepiece component. It also relates to a method for manufacturing a timepiece component using such a mold. It also relates to a timepiece component per se, obtained using such a method.

The existing methods for manufacturing timepiece components are unsatisfactory or unsuitable for manufacturing a component with complex geometry, that is, comprising inclined faces, for example forming a “clous de Paris” pattern, or comprising chamfers, bevels, or angling. They sometimes achieve certain complex geometries, but by means of painstaking steps such as post-machining. Generally, the existing methods for manufacturing timepiece components do not make it possible to manufacture complex shapes with sufficient precision.

The present invention thus aims to improve the known methods for manufacturing a timepiece component, and in particular to make it possible to manufacture a timepiece component having a complex shape simply and with a high degree of precision.

To this end, the invention is based on a method for manufacturing a mold for manufacturing a timepiece component, wherein the method comprises the following steps:
Producing a recess originating from an upper surface of a substrate, so as to form a recess delimited by at least one surface inclined relative to the plane in which said upper surface of the substrate extends;
Producing at least one wall of the mold comprising a step consisting of depositing a material on at least part of the upper surface of the substrate and/or of the recess, optionally covered with a conductive layer and/or an anti-reflective layer,
   so as to form a mold at least partially delimited by at least one wall of said material and by said at least one inclined surface of the recess, and optionally by at least part of the upper surface of the substrate.

The invention is more particularly defined in the claims.

These objects, features and advantages of the present invention will be disclosed in detail in the following non-limiting description of particular embodiments given with reference to the appended figures, in which:

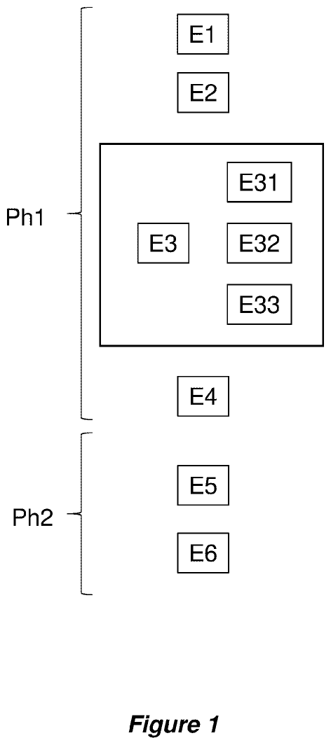

FIG. 1 is a schematic depiction of the steps of a method for manufacturing a timepiece component according to one embodiment of the invention.

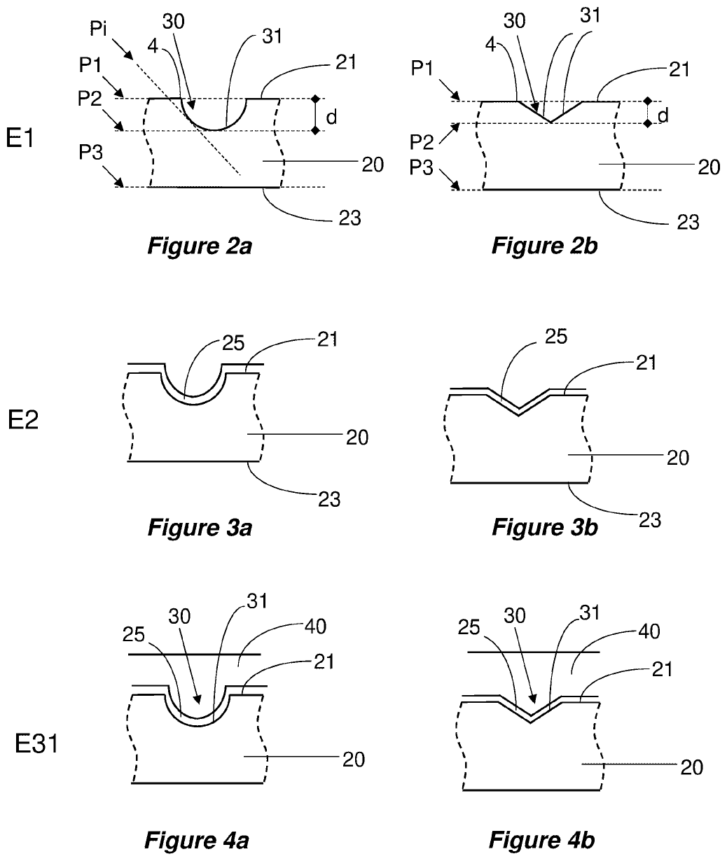

FIGS. 2a to 10a show cross-sectional views of the steps of a method for manufacturing a timepiece component according to a first embodiment of the invention.

FIGS. 2b to 10b show cross-sectional views of the steps of a method for manufacturing a timepiece component according to a second embodiment of the invention.

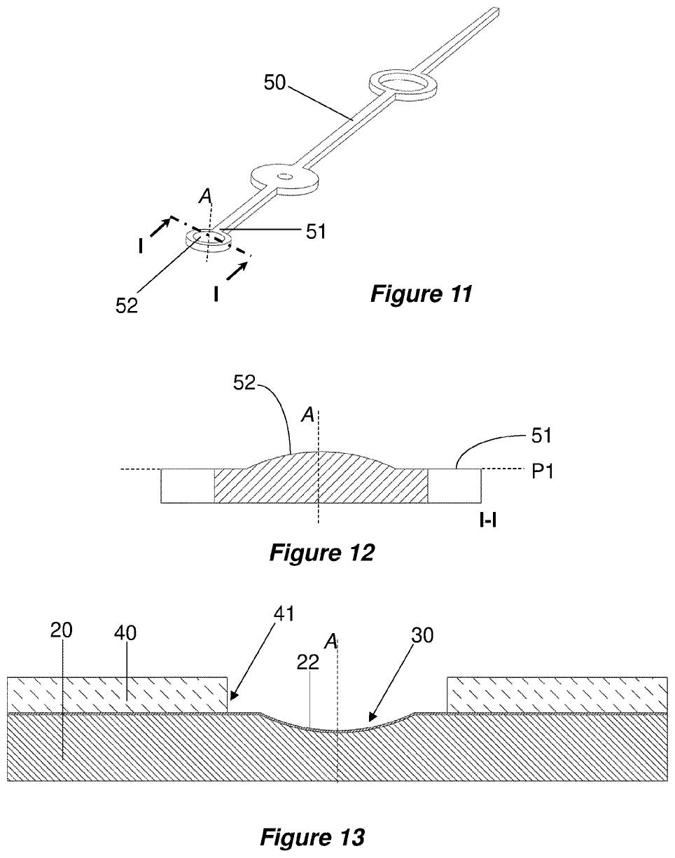

FIG. 11 shows a perspective top view of a hand according to one embodiment of the invention.

FIG. 12 shows a transverse cross-sectional view of one end of the hand according to the embodiment of the invention.

FIG. 13 shows a transverse cross-sectional view of a mold for manufacturing the hand according to the embodiment of the invention.

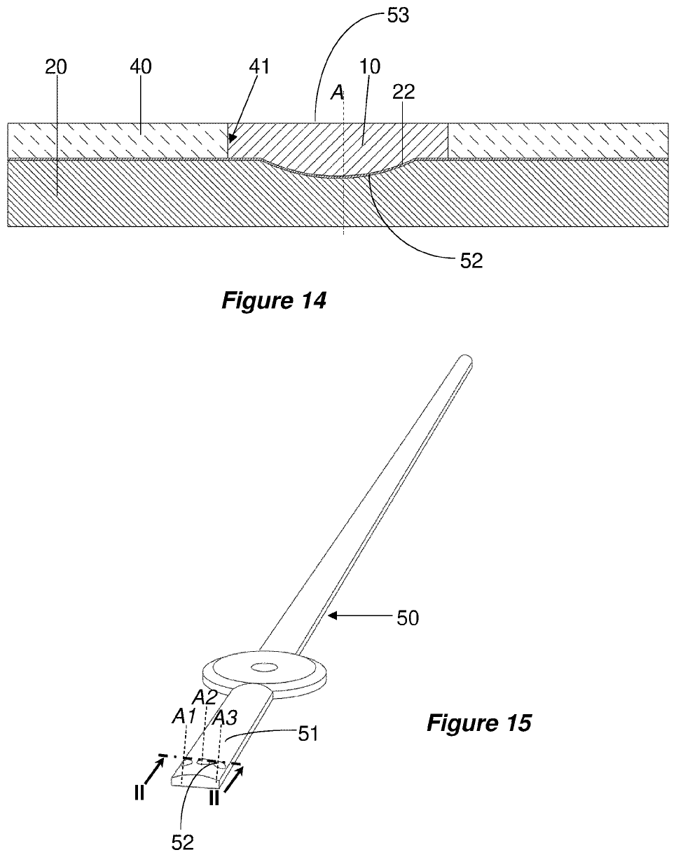

FIG. 14 shows a transverse cross-sectional view of a step of manufacturing the hand in the mold according to the embodiment of the invention.

FIG. 15 shows a perspective top view of a variant of the hand according to one embodiment of the invention.

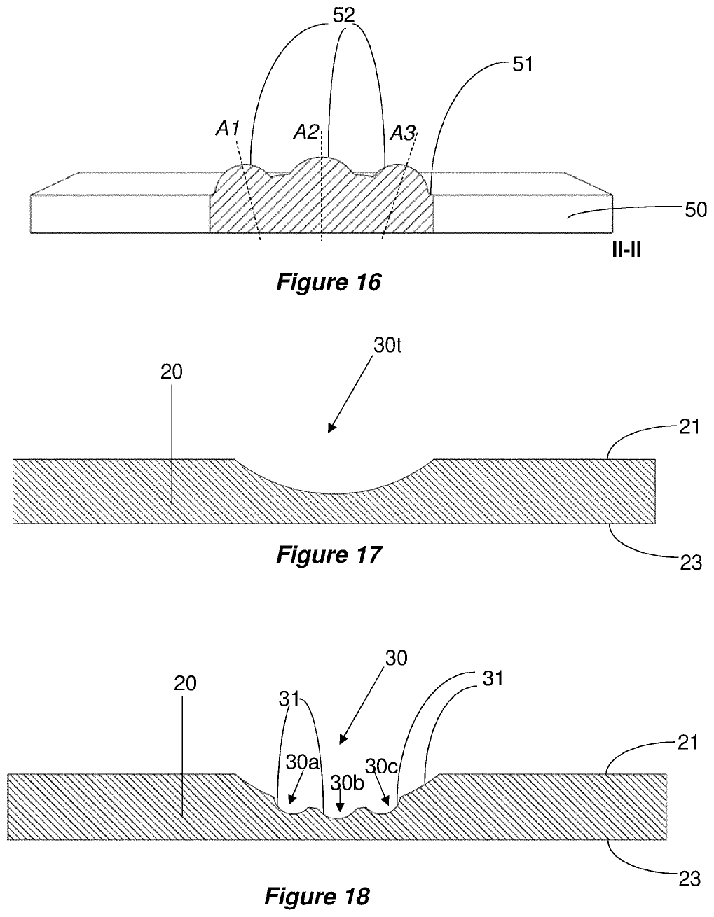

FIG. 16 shows a transverse cross-sectional view of one end of the variant of the hand according to the embodiment of the invention.

FIGS. 17 and 18 show transverse cross-sectional views of the steps of producing a recess in a substrate for manufacturing a mold for manufacturing the variant of the hand according to the embodiment of the invention.

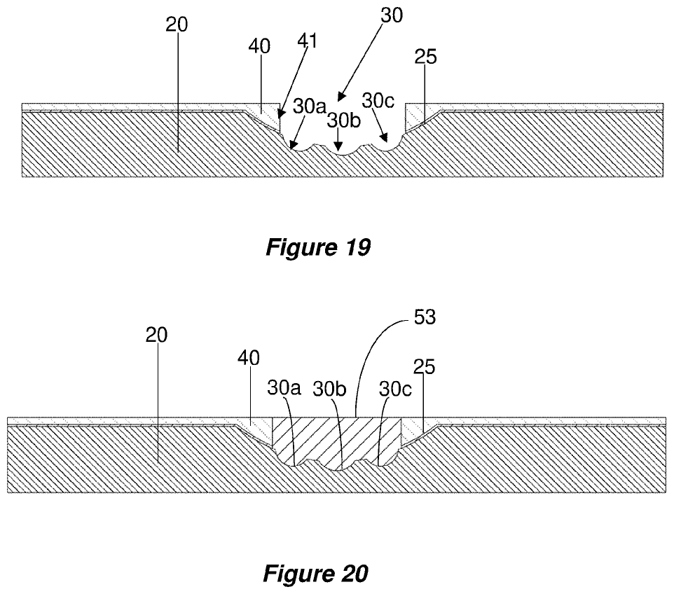

FIG. 19 shows a transverse cross-sectional view of a mold for manufacturing the variant of the hand according to the embodiment of the invention.

FIG. 20 shows a transverse cross-sectional view of a step of manufacturing the variant of the hand in the mold according to the embodiment of the invention.

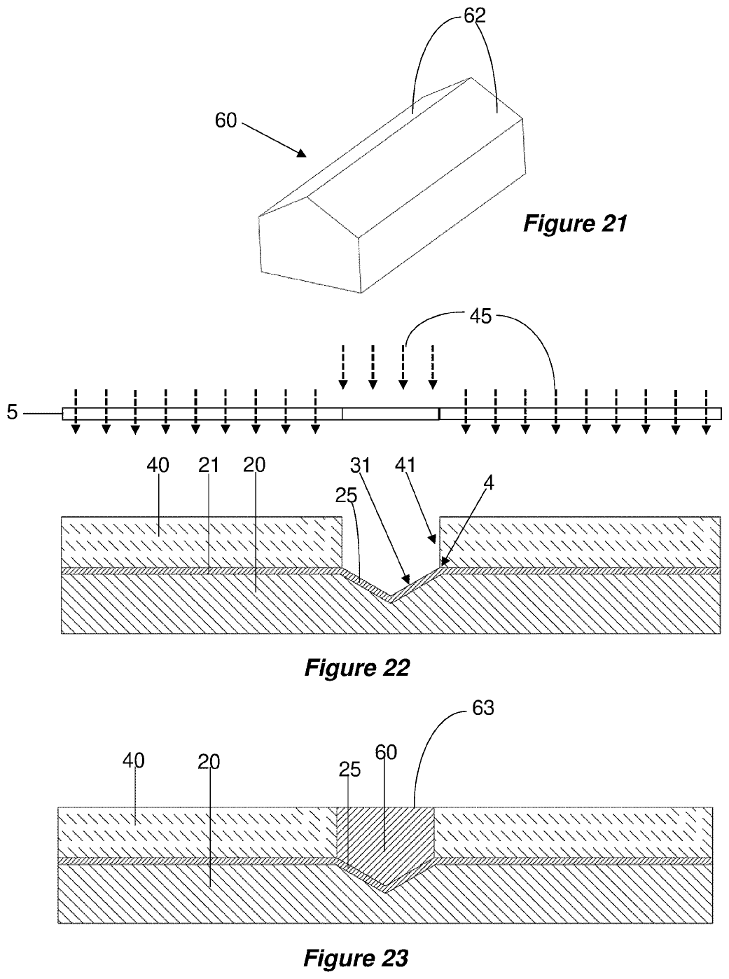

FIG. 21 shows a perspective top view of an applique according to one embodiment of the invention.

FIG. 22 shows a transverse cross-sectional view of a step of manufacturing a mold for manufacturing the applique according to the embodiment of the invention.

FIG. 23 shows a transverse cross-sectional view of a step of manufacturing the applique in the mold according to the embodiment of the invention.

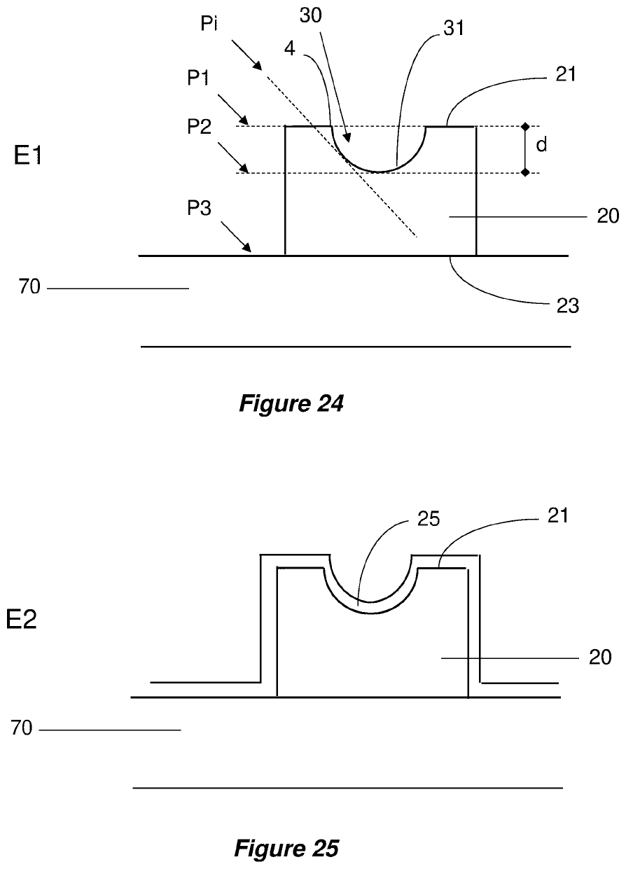

FIGS. 24 to 28 show cross-sectional views of steps of a method for manufacturing a timepiece component according to a third embodiment of the invention.

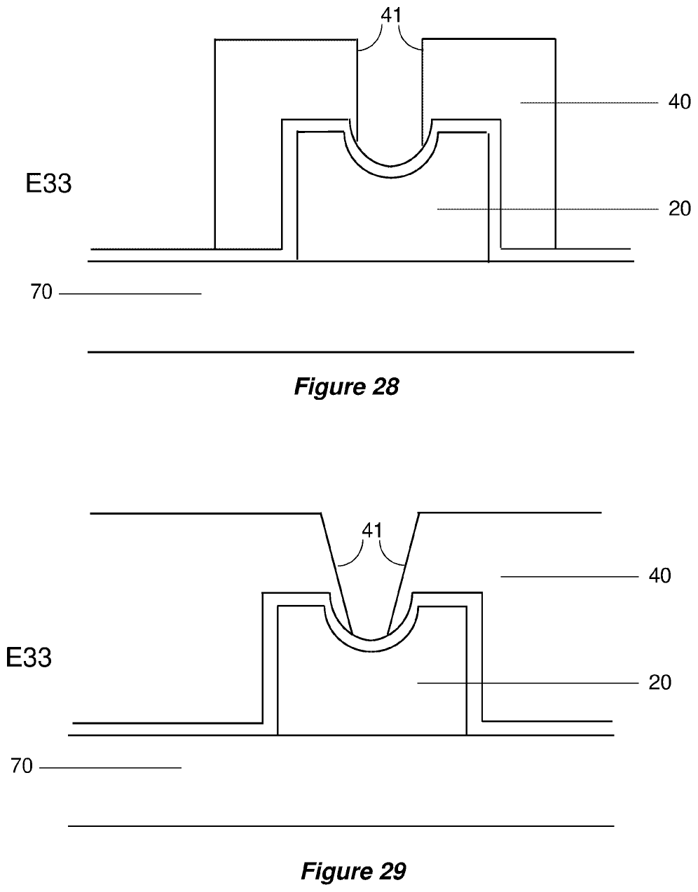

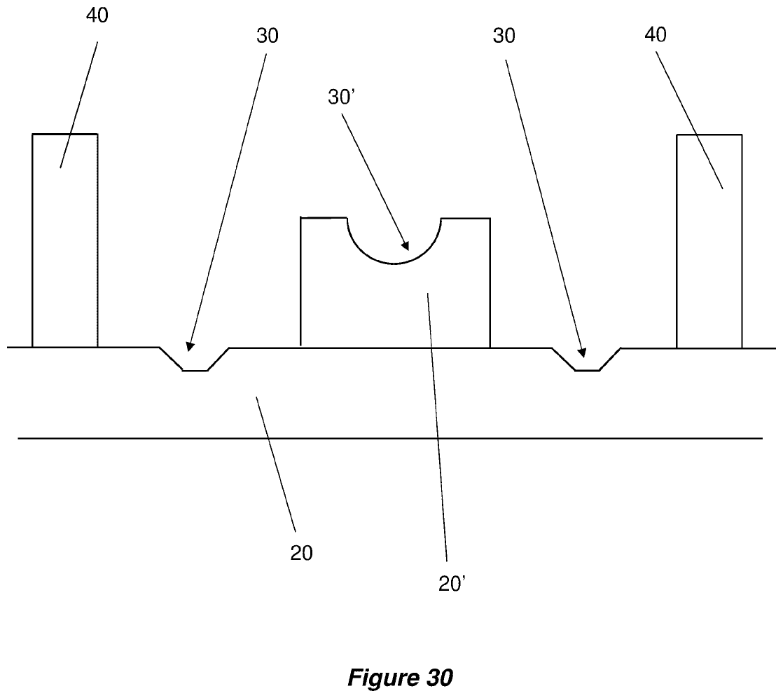

FIG. 29 shows a cross-sectional view of an overall variant represented in FIG. 28.

FIG. 30 shows a cross-sectional view of a step of a method for manufacturing a timepiece component according to a fourth embodiment of the invention.

The invention achieves the aims sought through the intermediate manufacturing of a particular mold, having a complex shape, in order to obtain a timepiece component having a complex shape by simple molding in said particular mold.

The invention firstly comprises a method for manufacturing a mold for manufacturing a timepiece component. It then comprises a method for manufacturing a timepiece component per se, the first phase Ph1 of which consists of implementing the method for manufacturing a mold and the second phase Ph2 of which is the use of such a mold for manufacturing a timepiece component per se, as depicted schematically in FIG. 1.

The method for manufacturing a mold for manufacturing a timepiece component according to particular embodiments chosen by way of illustrative example will first be described with reference to FIGS. 2a to 10a and 2b to 10b, and then 24 to 30.

The method comprises a prior step of obtaining a substrate 20 having a thin, substantially flat shape between a few hundred microns and a few millimeters thick according to the two first embodiments, comprising an upper surface 21 and a lower surface 23, which are potentially substantially parallel. The upper surface 21 is generally flat. As a variant, it may not be flat, for instance, it may be domed and/or it may have one or more recesses. In any event, reference will be made to the plane P1, in which said upper surface 21 extends, in order to simplify the description, said plane P1 being a tangent plane in the case of a surface that is not perfectly flat, as will be set out in detail hereinafter. The lower surface 23 likewise extends in a plane P3. The thickness of the substrate 20 is the distance between the two planes P1 and P3.

In addition, the substrate 20 can be made from a conductive material, such as a metal or a metal alloy, such as stainless steel, or from a non-conductive material, such as silicon, glass or ceramic, or from polymer, or from composite, for example in the form of a wafer or pad. The substrate preferably has low roughness. It can advantageously undergo a conventional preparation step, comprising the degreasing, cleaning, and optionally passivation and/or activation thereof. In addition, the substrate can be provided with markers so that it can be oriented precisely.

The method comprises a first step of producing E1 a recess 30 originating from the upper surface 21 of the substrate 20, so as to form a recess 30 delimited by at least one surface 31 inclined relative to the plane P1 in which said upper surface of the substrate extends. This plane P1 is considered at the interface 4 between the recess 30 and the upper surface 21 of the substrate 20, disregarding the recess, that is, considering a continuous upper surface at this interface 4. This interface forms an edge. As mentioned above, this plane is the plane tangent to the upper surface 21 of the substrate if it is not flat all over. Likewise, said inclined surface 31 of the recess 30 will be considered with reference to a plane Pi tangent to said inclined surface if it is not flat. Generally, the recess 30 comprises at least one inclined surface when it comprises at least one tangent plane Pi that is non-perpendicular or non-parallel to the plane P1 of the upper surface 21 of the substrate 20.

Advantageously, the inclined surface 31 has an inclination forming an angle of between 10 and 80 degrees relative to the upper surface 21 (that is, to the plane P1) at the interface 4 between this upper surface 21 and the recess 30.

FIG. 2a shows a first example of a recess 30 with a curved, rounded, continuous, concave surface. It has a transverse cross-section, that is a cross-section along a plane perpendicular to the plane P1 having a curved shape, generally forming a rounded U-shape. In this example, the recess 30 has an inclined surface 31 over substantially its whole surface.

FIG. 2b shows a second example of a recess 30 in the form of a conical surface forming a V-shaped transverse cross-section. As a variant, the recess can be triangular and have the same V-shaped transverse cross-section. Each arm of the V forms a straight section of an inclined surface 31 of the recess 30.

Naturally, the invention does not relate to the shape per se of the recess 30 and is not limited to the two embodiments illustrated. A recess 30 can comprise an inclined surface on just a sub-portion of the whole surface thereof. An inclined surface can be formed by a multitude of flat and/or curved facets, each of which is ultimately potentially an inclined surface as defined above. It can also be concave or convex. Generally, an inclined surface is therefore defined as a surface having an angle other than 0° or 90° to the plane P1 of the upper surface 21 of the substrate 20. An inclined surface 31 can be continuous or discontinuous. The angle that an inclined surface forms with the plane P1 can be constant or otherwise. An inclined surface can be flat and/or curved. In the case of a curved surface, the aforementioned angle can for example be characterized by the angle formed by a tangent at a given point of the inclined surface and the plane P1, this angle changing depending on the profile of the inclined surface. The angle that this inclined surface forms with the plane P1 can be seen more particularly in a cross-sectional view passing through a plane perpendicular to the plane P1, that is, by a transverse cross-section as defined above. It will be noted that this angle will be measured with a plane tangent to the upper surface 21 at the interface 4 in the case of a non-flat upper surface 21. In addition, one or more recesses 30 can be produced in the substrate 20. A recess 30 can comprise one or more inclined surfaces 31.

In addition, the recess 30 can be produced by any means known to a person skilled in the art, such as conventional mechanical machining, laser machining, laser etching, chemical etching or electrochemical dissolution. As a variant, a recess is not produced by a specific machining step, but can result directly from the manufacturing of the substrate 20, the upper surface 21 of which is locally not flat.

In any event, a recess 30 presents as a surface set back relative to the upper surface 21 of the substrate 20, hollowed out to a certain depth d in the thickness of the substrate 20.

According to a third embodiment, illustrated in FIGS. 24 to 28, the substrate 20 is at least partially like a layer or a pad, in which at least one recess 30 is produced in the form of a recessed zone, in particular by two-photon polymerization technology, known by its acronym TPP; this substrate 20 is made of resin, or of any material that can be structured by two-photon polymerization (for example some ormocers, photosensitive composites, some “glass ceramics”). This substrate 20 is positioned on a support 70, as illustrated in FIG. 24. In a variant which is not shown, the substrate 20 subjected to two-photon polymerization may be in the form of a plate with a similar shape to the substrate of the first two embodiments described.

It will be noted that this two-photon polymerization technology, used in this third embodiment, offers numerous advantages, including a great number of possible complex shapes, with overhangingly superposed zones for example, or a discontinuous structure, or a wave shape. This technique makes it possible moreover to achieve very high precision, with a definition of less than 100 nm, and a roughness Ra of less than 10 nm. It also makes it possible to operate over a large exposure volume. This technique makes it possible for example to produce locally curved and/or angled inclined walls.

As an alternative, a substrate 20 made of resin or another compatible material could be produced with a recess using stereolithography technique or a grey photolithography, with a lower resolution and limitations of shape.

The depth d of the recess 30 corresponds to the distance measured between the plane P1 of the upper surface 21 of the substrate 20 and a plane P2, parallel to the plane P1, passing through the point of the recess 30 furthest from the plane P1. This depth d is measured in a direction perpendicular to the planes P1 and P2, that is, perpendicular to the upper surface 21 of the substrate 20. Preferably, the depth d of the recess is less than or equal to 1000 μm, or less than or equal to 500 μm, or less than or equal to 400 μm. In addition, the depth d is preferably greater than or equal to 10 μm, or greater than or equal to 50 μm, or greater than or equal to 80 μm, or greater than or equal to 100 μm.

As will become apparent hereinafter, the recess 30 will act as at least part of a mold for manufacturing a timepiece component. More specifically, it will be used to define a complex shape of a timepiece component, to make it possible to produce it advantageously by simple molding, without requiring an additional machining step. It will be noted that the recess therefore has a shape suitable for the future demolding of the portion of the timepiece component that will be molded in this recess. To this end, according to one exemplary embodiment, the area of the cross-sectional area of the recess, along a plane parallel to the plane P1 in which the upper surface 21 of the substrate extends, at any depth, is less than the open cross-section of the recess, that is, at the interface 4 between the recess 30 and the upper surface 21 of the substrate 20. According to another exemplary embodiment, the area of the cross-section of the recess 30, parallel to the plane P1 in which the upper surface 21 of the substrate extends, decreases moving away from said plane P1. It will also be noted that the substrate 20 has the sole function of forming part of the mold for manufacturing the timepiece component, and does not belong to the future timepiece component. As a remark, the third embodiment shown in FIGS. 24 to 29 involves a support 70, which does not form a surface of the mold, nor a part of the future timepiece component.

Optionally, and not shown, a conductive layer can be deposited on all or part of the upper surface 21 of the substrate 20, and at least partially on the recess 30, particularly on the inclined surface thereof. Such a conductive layer is necessary when the substrate is not made from a conductive material, and when the second manufacturing phase requires a conductive mold, as will be set out in detail hereinafter. This conductive layer can in particular be suitable for acting as an electrode for initiating an electroforming, electrodeposition or electroplating step, in view of the future metallic growth of the timepiece component. As is known, this conductive initiation layer can comprise a sub-layer of chromium, nickel or titanium covered with a layer of gold or copper, and thus take the form of a multi-layer structure. Such a conductive layer can be deposited using a physical vapor deposition (PVD), or chemical vapor deposition (CVD), or atomic layer deposition (ALD), or pulsed laser deposition (PLD) method, by thermal evaporation, or by any means known to a person skilled in the art.

The method according to the embodiment then comprises a step E2 that can be optional, consisting of applying an anti-reflective treatment to the substrate, the function of which will be explained hereinafter. According to the embodiment, this step is implemented by a step consisting of depositing an anti-reflective layer 25 on the substrate 20 on at least part of the upper surface 21 thereof and/or of the recess 30 that is not perpendicular to incident exposing radiation suitable for exposing the resin, which will be implemented in a subsequent step described below. The application of an anti-reflective layer 25 relates in particular to the inclined surface 31 of the recess 30, given that it is generally preferable to apply exposing radiation perpendicular to the plane P1 in which the upper surface 21 of the substrate 20 extends. The anti-reflective layer 25 can extend over all or part of the upper surface 21 and/or of the recess 30 of the substrate 20, as shown in FIGS. 3a and 3b, or even additionally over part of a support 70, as is shown in FIG. 25.

Preferably, the anti-reflective layer makes it possible to attenuate more than 98%, or more than 99%, or more than 99.9% of the reflection of exposing radiation, in particular UV (ultraviolet) radiation. The anti-reflective layer can be of any chemical type known to a person skilled in the art. It can comprise an organic material. In particular, it can be a layer of material known by the trade name AZ®-BARLi® II.

The anti-reflective treatment can comprise depositing an anti-reflective layer 25 by spin coating, or spray coating, or dip coating, or chemical vapor deposition (CVD), or physical vapor deposition (PVD), or atomic layer deposition (ALD), or pulsed laser deposition (PLD), or by any means known to a person skilled in the art. As a variant, the step consisting of applying E2 an anti-reflective treatment to the substrate can comprise a particular structuring of the upper surface 21 and/or of the recess 30 of the substrate 20, or even of the surface of a support 70. Such a physical structuring of the upper surface 21 of the substrate can be done, in particular, by sand blasting, for example using a laser.

The method according to the embodiment then comprises a step E3 consisting of forming at least one wall of the mold, by depositing E31 a material in particular a resin, on the upper surface and/or the recess 30 of the substrate, so as to complete the mold, which is thus formed by the combination of the resin and a portion of the substrate. Advantageously, the sub-step consisting of depositing E31 a material is such that it forms walls of the manufacturing mold, these walls supplementing the substrate, and in particular all or part of a recess of the substrate, which forms all or part of the base of the mold. As a variant, a material other than a resin could be used to form the mold, for example a polymer such as a silicone polymer (PDMS), or any material that can be structured by nanoimprint lithography, or any laser-structured polymer, or as a variant any other material such as silicon, held by gluing (including bonding).

According to this embodiment, a resin is deposited during this step using a photolithography technique, the step comprising a plurality of sub-steps that will be set out in detail below.

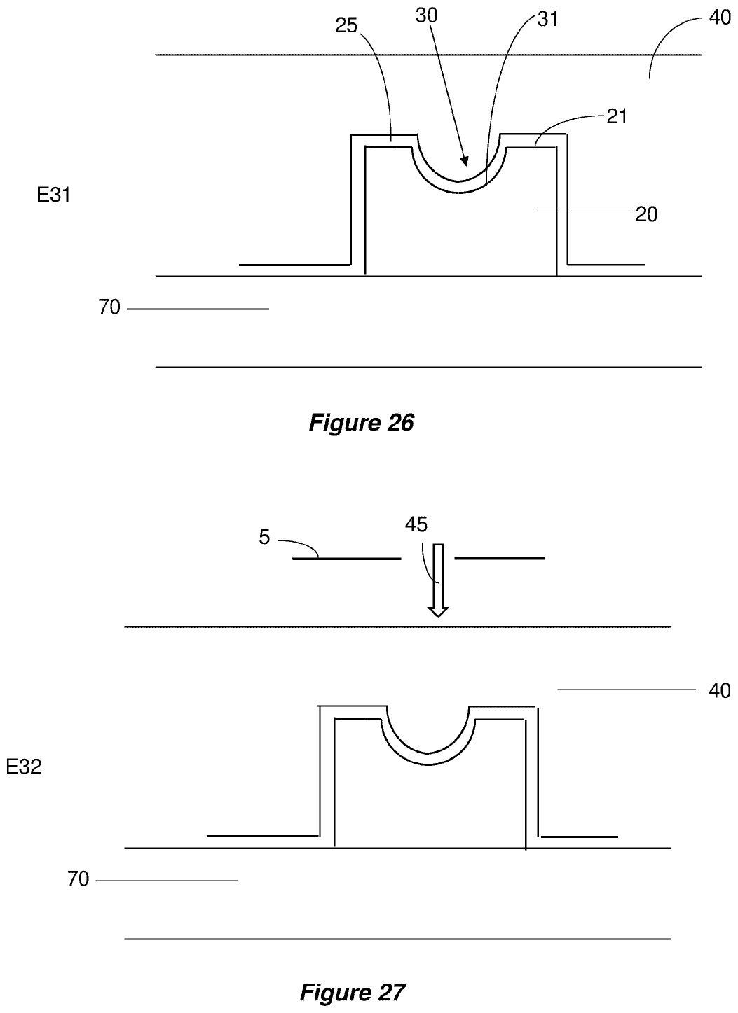

Firstly, this step comprises a sub-step consisting of depositing E31 a layer of photosensitive resin 40 on all or part of the upper surface 21 and/or of the recess 30 of the substrate 20 and possibly of a support 70 (optionally covered with a conductive layer and/or an anti-reflective layer 25 as explained above), in particular at least partially on a recess 30, and in particular on an inclined surface 31 of a recess 30, as illustrated in FIGS. 4a and 4b and 26.

The photosensitive resin can be negative or positive. If the former, it is designed to become insoluble or soluble with difficulty with a developer under the action of exposing radiation (i.e. the exposed regions resist development) while, if the latter, it is designed to become soluble with a developer under the action of exposing radiation, while the part not exposed to the radiation remains insoluble or soluble with difficulty.

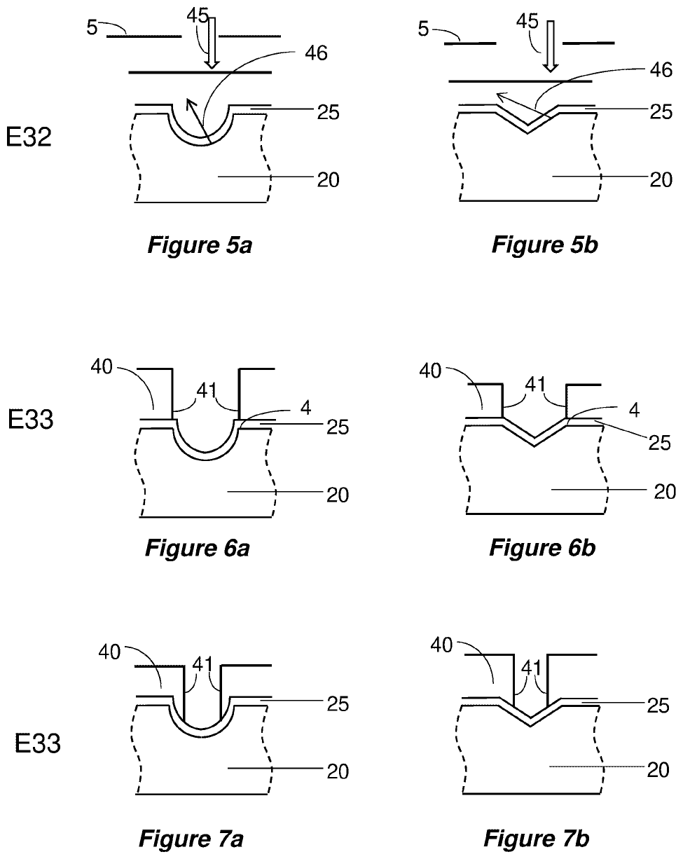

The method then comprises a sub-step consisting of exposing E32 said photosensitive resin 40 by incident exposing radiation 45 through a mask 5, as shown in FIGS. 5a and 5b and 27. The exposing radiation 45 can be UV radiation in order to expose the photosensitive resin 40 in a pattern defined by the mask 5, which includes openings and opaque regions corresponding to this pattern. Alternatively, exposure can be carried out by direct writing (and therefore without the need for a mask) using a laser or an electron beam in the predefined pattern. The exposing radiation 45 can be X-Ray, UV, visible, IR (infrared) radiation, or an electron beam.

According to one advantageous embodiment, the exposing radiation 45 used is perpendicular or substantially perpendicular to the plane in which the mask 5 extends, the mask itself being parallel to the plane P1 of the upper surface 21 of the substrate 20, so as to irradiate only the regions of the photosensitive resin 40 situated in line with the openings made in the mask 5. These irradiated regions are thus defined by walls perpendicular or substantially perpendicular to the plane P1. These walls are then referred to as “straight walls” by definition. As a variant, the exposing radiation 45 can be inclined relative to the plane P1 of the substrate 20, such incident radiation then defining inclined walls of the resin.

Next, the step consisting of depositing a resin comprises a sub-step consisting of developing E33 the resin, as illustrated by FIGS. 6a, 6b, 7a, and 7b, 8a, 8b, 28 and 29 according to alternative embodiments. Note that FIG. 29 illustrates an overall variant of FIG. 28 of the third embodiment, in which the variant is the result obtained after development, following an aforementioned step E32, during which said variant is tilted and rotated with respect to the exposure radiation during the polymerization of the resin 40 of the substrate 20. If the resin is negative, developing consists of removing the unexposed regions of resin, for example by dissolving with a chemical product or by plasma treatment. If a positive photosensitive resin is used, the exposed regions are removed during developing and the unexposed regions are retained on the substrate. After developing, the substrate 20 is visible where the resin has been removed. The remaining portions of resin define the walls of the mold and the portion of substrate circumscribed by the mold walls defines the base of the mold. A mold is thus formed by the combination of a portion of the substrate and a resin portion.

As explained above, the mask 5 makes it possible to define the regions of the resin that must be exposed or not, in order to ultimately define the geometry of the resin walls of the mold and therefore of the mold. To achieve sufficient precision of the mold, it is important to limit, or prevent, any stray exposure, that is, any undesired exposing radiation that might reach the resin. Such stray exposing radiation 46 could exist as shown in FIGS. 5a and 5b in the absence of an anti-reflective treatment of the substrate 20. Stray exposing radiation 46 can originate from the exposing radiation 45 reflecting on a surface of the substrate 20, resulting in reflected radiation reaching the resin in undesirable regions. In particular, stray exposing radiation might reach regions of the resin intended to form walls of the future mold, which would then form a mold including irregularities on its resin walls, which is undesirable as it could result in the presence of small cavities (or small protrusions, depending on the type of resin) on the walls of the timepiece components ultimately produced in such a mold.

The phenomenon of stray exposing radiation can particularly be caused by an inclined surface 31 of a recess 30. As a variant, such a stray reflection configuration can also occur in the event of incident exposing radiation 45 that is non-perpendicular to the substrate 20, and in particular to its upper surface 21 when it is not flat. The existence of stray exposing radiation is relatively foreseeable as it depends on the geometry of the selected configuration. When there is a risk of stray exposing radiation, the optional step consisting of applying E2 an anti-reflective treatment to the substrate will thus preferably be implemented, as described above, thus fully or partially eliminating the occurrence of such stray exposing radiation, and thus guaranteeing the precise formation of a mold as defined by the mask 5.

In summary, when the direction of the incident exposing radiation is non-perpendicular to the surface on which the resin to be exposed is deposited, and/or when the substrate comprises inclined surfaces that are not perpendicular to the direction of the incident exposing radiation, this results in a risk of stray exposure of the resin outside the region directly exposed by the incident exposing radiation. This stray exposure is detrimental to the definition of the mold as it laterally exposes regions of resin that should not be exposed. For example, in the case of a substrate 20 with a flat, polished upper surface 21, the exposing radiation 45 incident on a positive resin 40 in a direction perpendicular to the plane P1 reflects on the inclined surfaces 31 of the recess 30 produced in the substrate 20, generating stray reflections forming stray exposing radiation 46, non-perpendicular to the plane P1, as illustrated in FIGS. 5a and 5b.

According to one variant embodiment, the resin walls forming a portion of the mold can be produced as described in EP3670441, combining at least one step based on conventional photolithography as described above and at least one step based on the two-photon polymerization technique, therefore in accordance with the same technique as that used to form the recess in the resin of the substrate 20 in the third embodiment of the invention.

It will be noted that the preceding steps may also be applied identically to the embodiment shown in FIG. 24, as illustrated schematically in FIGS. 25 to 28, which will not be described in more detail.

Furthermore, the resin mold portion can be multi-layer, involving at least one step based on conventional photolithography with a first resin layer, comprising a first opening, and a second resin layer made from a rigid film, comprising a second opening.

As a variant, the order of steps E1 and E3 can be reversed.

Following the steps consisting of producing E1 a recess and E3 forming at least one wall of the mold, a mold is thus formed by the combination of the substrate and said material (resin 40), as explained above. The substrate 20, in particular a recess 30 having at least one inclined surface 31 as defined above, makes it possible to define a complex shape of a timepiece component to be manufactured. The material, such as the resin 40, in particular the perfectly defined walls 41 that it forms from the substrate 20, defines the walls of a timepiece component to be manufactured.

It will be noted that a plurality of configurations can be envisaged for the positioning of a wall 41 of resin 40 on the substrate 20.

According to a first configuration shown in FIGS. 6a and 6b, a wall 41 of the resin can be formed in line with the interface 4 between a recess 30 and the upper surface 21 of the substrate. In such a case, a wall extends perpendicular to the plane in which the upper surface of the substrate extends at the location of the edge formed at the end of the recess 30, that is, on the periphery of the recess 30.

The manufacturing quality of the mold has a direct impact on the timepiece component manufactured in this mold. It is apparent that the precise positioning of a wall 41 of resin in line with the edge defining the perimeter of the recess 30 as described is not easy. An offset at this junction of a resin wall 41 can generate a defect on the mold, and then a defect, for example a protrusion or other defect, on a manufactured timepiece component.

To reduce this risk, a second configuration, shown in FIGS. 7a and 7b, 28 and 29, consists of producing at least one wall 41 inside a recess 30, to eliminate the need for precise positioning on the interface 4. In such an approach, a recess 30 is made with a larger shape than the timepiece component to be manufactured, and is then delimited by a wall 41 positioned inside the recess.

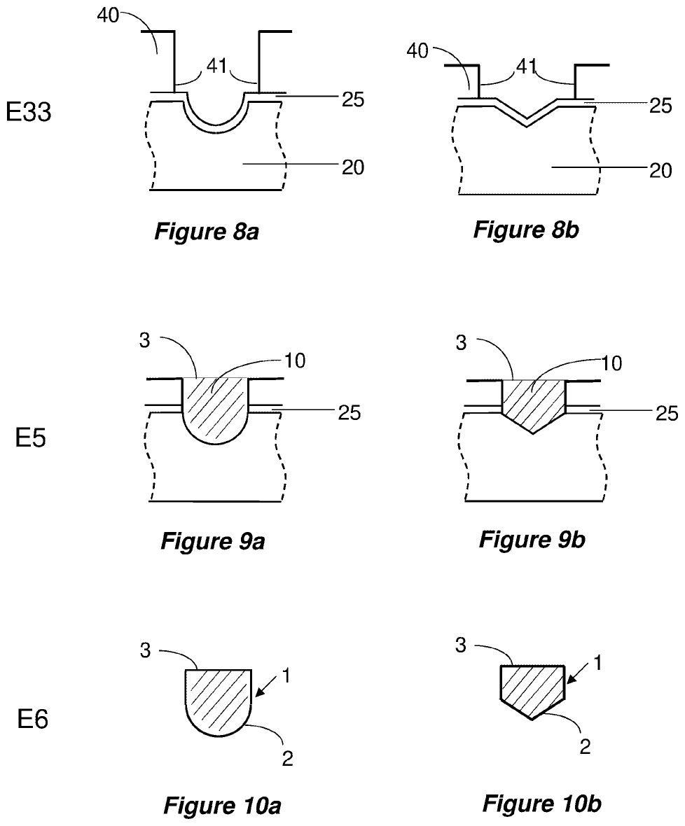

According to a third configuration shown in FIGS. 8a and 8b, the photosensitive resin forms at least one wall 41 outside said recess, that is, the resin wall extends from the upper surface 21 of the substrate, on the outside of the interface 4 with a recess 30.

The invention is not limited to the embodiments described. By way of example, FIG. 30 illustrates the manufacture of a mold according to a fourth embodiment, which combines one of the first two embodiments with the third embodiment. Specifically, the mold firstly comprises at least one recess 30 produced in a first substrate 20, with application of a process similar to that described with reference to the first two embodiments, and at least one recess 30′ produced in a second substrate 20′, positioned on the first substrate 20, with application of the third embodiment of the invention. In this fourth embodiment, the first substrate 20 thus also performs the function of supporting the second substrate 20′.

Of course, other embodiments can be envisaged, in particular in accordance with an approach similar to FIG. 30, in which the recesses may be formed using different techniques.

Finally, the method for manufacturing a mold can comprise an optional step E4, not shown, of partially or fully removing an anti-reflective layer 25, for example after the sub-step consisting of developing the photosensitive resin using exposing radiation, if of course a step consisting of applying E2 an anti-reflective treatment has been implemented. Such removal of an anti-reflective layer 25 is however not mandatory in all cases. Such removal, when it is implemented, is applied to the substrate 20 belonging to the mold for manufacturing a timepiece component, that is, between the resin walls 41. This removal can be carried out mechanically or chemically, for example by stripping, or by plasma treatment.

Finally, as described above, the method makes it possible to form a mold, the base of which is formed by all or part of at least one recess 30 of the substrate 20, and optionally a portion of the upper surface 21 of the substrate, and the sides of which are at least partially defined by resin walls 41. The substrate 20 and the at least one recess 30 therefore form portions of the mold, and do not under any circumstances belong to the future timepiece component that will be manufactured.

In a particular mold variant, the mold consists entirely of a recess 30 of the substrate, without resin walls 41, and step E3 is not then implemented.

According to one embodiment, the at least one recess is produced by a material removal technique, in particular by machining. According to another embodiment, the at least one recess, or even walls of the mold, is obtained, in whole or in part, by a two-photon polymerization or grey photolithography or stereolithography technique.

The invention also relates to a method for manufacturing a timepiece component per se, the first phase Ph1 of which consists of implementing the method for manufacturing a mold as described above. The second phase Ph2 of the manufacturing method is based on the use of such a mold for manufacturing a timepiece component per se. An embodiment of this second phase will now be described.

The second phase of the manufacturing method firstly comprises a step consisting of filling E5 all or part of said mold resulting from said first phase with a material of said timepiece component, which will be referred to as the component material 10, as illustrated in FIGS. 9a and 9b. This step consisting of filling E5 the mold can comprise a step of electrodeposition, electroforming, electroplating, slip casting, thermoforming, or a step of filling by casting the component material.

According to an advantageous embodiment, this filling step can thus be carried out by electroforming a metal material. In such a case, the mold must be at least partially made from a conductive material, to act as an electrode for initiation, with in view of the future metallic growth of the timepiece component in the mold. If the substrate is not made from a conductive material, such a conductive layer is thus added to the substrate in the first phase of manufacturing the mold, as described above.

As a variant, the mold can be used for slip casting in order to obtain a ceramic timepiece component. According to another variant, a composite material or metallic glass can be cast or shaped in the mold.

The method then comprises a step consisting of detaching E6 the timepiece component 1 obtained in the previous step from the mold (in other words demolding), as shown in FIGS. 10a and 10b. For this demolding step, the substrate 20 and the at least one recess 30 therefore have features making them suitable for the demolding of the timepiece component 1. In addition, the resin forming the mold is dissolved. The dissolution can be done by any technique known to a person skilled in the art, as chemical dissolution, deep reactive-ion etching (DRIE), or laser ablation. Additionally, optionally, the component can be detached from the substrate.

As a result of the method described above, the entire surface 2 of the timepiece component 1 formed in direct contact with the mold according to the invention has a perfect final shape on demolding, without any need for additional operations. The invention thus makes it possible to very simply manufacture a timepiece component 1 comprising a complex shape, in particular corresponding to the recess 30 and its inclined surface(s) 31. The timepiece component 1 thus comprises at least one inclined surface, which is at least locally non-perpendicular and non-parallel to other surfaces of the timepiece component, in particular two main faces, parallel to each other, or inclined relative to the surface of the component formed by the base of the particular mold.

Optionally, a finishing step can be implemented on the face 3 opposite the base of the mold, which is not formed directly by the mold obtained using the method according to the invention. This finishing step can consist of polishing or grinding this opposite face 3 of the timepiece component, for example to ensure that it is flat. In addition or as a variant, this finishing step can consist of changing the color or the tribological properties of at least part of the surface of the timepiece component by depositing a coating formed by a physical vapor deposition PVD, or chemical vapor deposition CVD, or atomic layer deposition ALD, or pulsed laser deposition PLD method. It will be noted that this finishing step is applied to the opposite face 3 of the timepiece component not directly in contact with the mold. It can therefore be carried out before or after the step consisting of detaching E6 the timepiece component from the mold. As a variant, the finishing step, particularly a coloring step, can be applied to the whole timepiece component.

According to another embodiment, the timepiece component material is a metal or a metal alloy, in particular nickel-, gold-, or copper-based. According to another embodiment, the component material can be ceramic-based, or composite material-based, that is, it can fully or partially comprise a ceramic or a composite material, advantageously at least 50% by weight ceramic or composite material. The resulting timepiece component is thus predominantly made from a metal or a metal alloy, for example nickel-, gold-, or copper-based, or is predominantly made from a ceramic or a composite material.

The method for manufacturing a timepiece component as described above is suitable for manufacturing a multitude of different timepiece components. By way of example, the timepiece component can be an exterior timepiece component such an applique or a hand, or a component of the movement, such as an escapement wheel, or a lever, or a spring.

The invention also relates to a timepiece component per se. A major advantage of the invention is that it makes it possible to manufacture timepiece components with complex shapes that could not previously be produced.

In particular, the invention makes it possible to manufacture a timepiece component wherein the timepiece component is predominantly in one piece, preferably integrally formed. It can comprise a surface formed by the mold of the invention, comprising a first surface extending in a first plane, and a second surface inclined relative to this first surface, in particular domed and/or concave and/or convex and/or faceted and/or comprising at least one sharp edge, corresponding to one or more inclined surfaces of one or more recesses of the mold as defined above. This inclined surface can comprise at least one sharp edge, for example in the production of “clou de Paris” patterns, and optionally polished or structured surfaces. The inclined surface can take the form of a surface comprising a plurality of inclined portions, in particular comprising a profile in the form of wavelets. The inclined surface can also comprise sharp edges, and/or chamfers, and/or bevels, and/or angling. Such an inclined surface can have a predefined roughness.

According to one variant embodiment, the timepiece component can comprise one or more aesthetic or functional inserts. To this end, the manufacturing method can comprise an intermediate step consisting of arranging at least one insert in the manufacturing mold, before the step of filling the mold with the component material, involving rigidly connecting this component material to the at least one insert. Such an insert can be a decorative precious stone, or a jewel.

Furthermore, the timepiece component is advantageously made in one piece, or even integrally formed, with the exception of an optional insert. Alternatively, the timepiece component or the timepiece can consist of at least two associated distinct parts, at least one of which results from the manufacturing method according to the invention.

The invention also relates to a timepiece comprising at least one timepiece component according to the invention.

The invention also relates to a mold for manufacturing a timepiece component, wherein the mold comprises a substrate at least part of the upper surface and/or a recess 30 of which forms a base of the mold, comprising at least one inclined surface of a recess formed originating from said upper surface of the substrate level with the base of the mold, the mold further being at least partially delimited by a resin deposited on said substrate, in particular by a photosensitive resin, forming at least part of the walls of the mold.

The resin can form at least one wall of the mold in line with the periphery of said recess of the substrate, and/or the resin can form at least one wall of the mold inside said recess, and/or outside said recess, originating from the upper surface of the substrate. The resin can form all or part of the walls of the mold.

Said at least one inclined surface of the recess of the substrate can have an inclination forming an angle of between 10 and 80 degrees relative to the upper surface of the substrate considered at the interface between this surface and the recess. This inclined surface can be rounded or formed by a multitude of flat facets, can comprise one or more sharp edges, and can in particular be concave or convex.

The invention thus achieves the aims sought and more generally has the following advantages:
The manufacturing method is simple to implement and low-cost;
The manufacturing method makes it possible to obtain a timepiece component having a complex shape.

The invention will now be described in the context of the actual manufacturing of a number of particular timepiece components, selected by way of non-limiting example.

According to a first example, the timepiece component is a hand 50, shown in FIG. 11, comprising an end having a complex visible surface, comprising in particular an inclined portion 52 that is domed relative to the surrounding flat upper surface 51. This inclined portion 52 can be seen more particularly in the transverse cross-sectional view along the line I-I in FIG. 12. It forms a protruding spherical cap, having an axis of revolution A perpendicular to the plane P1 of the hand 50.

The method for manufacturing this hand 50 implements the steps according to the embodiments described above. It will be described briefly hereinafter.

In a first step E1, the method consists of producing a recess 30 using a deep reactive-ion etching (DRIE) method on a silicon substrate 20, taking advantage of grey photolithography. Here, the shape of this recess corresponds to the domed face in the form of a spherical cap. The depth d of the recess is 50 μm. After the recess 30 has been produced, a conductive layer 22 is deposited on the substrate 20.

Walls 41 of the mold made from resin 40 are then formed in a third step E3. To this end, the following sub-steps are implemented:
A photosensitive resin 40, SU-8, an epoxy-based negative resin that cross-links under the action of UV radiation, suitable for conventional photolithography, is deposited on the surface of the conductive layer 22.
The photosensitive resin 40 is then subjected to UV exposing radiation, through a mask, in order to cross-link it in a pattern defined by the mask. Here, the pattern corresponds to the perimeter of the hand 50. The exposing radiation used is perpendicular to the plane in which the substrate 20 extends, so that only the regions of the resin 40 situated in line with the openings made in the mask are irradiated, corresponding to the resin portion to be retained in order to form the mold. These regions are thus defined by vertical walls 41, i.e. perpendicular to the plane P1 of the substrate 20. These straight resin walls correspond to the faces of the hand forming the sides thereof. It will be noted that the presence of an anti-reflective layer 25 on the substrate 20 is not necessary here, as the regions situated on the border of the recess 30 could not be irradiated by stray reflections of the incident exposing radiation, due to the geometry of the hand and the use of a negative resin.
The photosensitive resin 40 is then developed. As the resin 40 is negative, developing consists of removing the unexposed regions of resin. These regions of resin 40 are removed by dissolving with a PGMEA-based chemical product (propylene glycol methyl ether acetate).

After developing, the conductive layer 22 is visible where the resin has been removed. The remaining portions of resin 40 and the visible base of the substrate (covered by the conductive layer 22) define the geometry of the mold, shown in FIG. 13. Here, the substrate 20, and in particular the recess 30, define the inclined visible face of the complex-shaped hand 50.

The fifth step E5 of the method consists of manufacturing the hand by electrodeposition of the component material 10 in order to fill the mold. Here, the mold is filled with electroformed 24-carat gold. FIG. 14 illustrates the mold in FIG. 13 filled following step E5.

The sixth step E6 of the method consists of detaching the hand 50 from its mold. Here, the visible inclined face 52 of the complex-shaped hand 50 obtained corresponds strictly with the base of the mold and the required geometry. It can be used directly following step E6, without post-processing, that is, without reworking or tribofinishing, of the inclined face 52 and the surrounding flat upper surface 51, defined by the substrate 20 of the mold. The opposite face 53 of the hand 50, which was not in contact with the mold, is polished to ensure that it is flat.

According to a second example forming a variant of the first example, the timepiece component is a hand 50, shown in FIGS. 15 and 16, comprising an end having a complex visible surface, comprising a plurality of distinct inclined portions 52 in the form of three domed caps protruding from the visible upper surface of the hand, relative to the surrounding domed upper surface 51. These three substantially spherical caps have respective axes of revolution A1, A2, A3, substantially perpendicular to the upper surface 51 of the hand 50.

The method for manufacturing this hand 50 implements the steps according to the embodiments described above. It will be described briefly hereinafter.

FIGS. 17 and 18 more particularly show the first step E1 of the method, which consists of producing a recess 30 in a substrate 20, which consists of a flat stainless steel wafer. The recess 30 is produced by electrochemical dissolution, in two stages. A first dissolution initially forms the domed face of the hand 50, forming a temporary recess 30t, shown in FIG. 17. Three recesses 30a, 30b, 30c in the shape of concave caps are then formed at the bottom of the temporary recess 30t previously obtained, to provide the final geometry of the recess 30, shown in FIG. 18. This recess 30 corresponds to the complex shape of the end of the hand 50, shown in particular in FIG. 16. It will be noted that this recess 30 thus defines a plurality of inclined surfaces 31. The depth d of the recess is 50 μm.

The second step E2 of the method consists of depositing an anti-reflective layer 25 on the substrate 20. The anti-reflective layer 25 is formed by a layer of the material referred to by its trade name AZ®-BARLi® II. It is deposited by a spin coating method.

The third step E3 of the method is the step of forming the walls 41 of the mold from resin 40. It comprises a plurality of sub-steps, similar to those described above. It will be noted that the walls 41 are positioned inside the recess 30 in this embodiment. After exposure and development of the resin, the remaining portions of the resin 40 and the visible substrate 20, in particular at least a recess portion 30, define the mold.

A fourth step of the method consists of removing E4 the anti-reflective layer 25 in the openings in the resin, that is, in the base of the mold, so that the substrate 20 is revealed, as shown in FIG. 19. Here, the anti-reflective layer is removed by oxygen plasma treatment.

The fifth step E5 of the method consists of manufacturing the component by electroforming by filling the previously obtained mold, as shown in FIG. 20. As the substrate 20 is manufactured from an electrically conductive material, the electroforming method can start and continue on from the growth initiated on the conductive region, along the walls 41 made from photosensitive resin. The hand 50 can for example be produced from nickel or gold.

The sixth step E6 of the method consists of detaching the complex-shaped hand from its mold. The inclined face of the hand has polished surfaces corresponding to the recess 30 (and to the recesses 30a, 30b, 30c it contains) produced in the substrate 20, having dimensions and slopes corresponding strictly with the required geometry. This visible surface defined by the cavity of the recess 30 of the substrate is used directly following this step E6, without post-processing, that is, without reworking or tribofinishing. The geometry of this surface from the mold is not touched up.

The opposite face 53 of the hand is the result of the end of the growth by electroforming, and this opposite face 53 can be polished and adjusted before or after demolding.

The hand may thus have straight walls or beveled walls, for example.

The timepiece component can then be colored by any technique known to a person skilled in the art (ALD, PVD, PLD, pad printing, etc.).

According to a third example, the timepiece component is an applique 60, shown in FIG. 21, comprising a bevelled complex visible surface, formed by two flat inclined surfaces 62 forming a transverse cross-section in the shape of an inverted V.

The first step E1 of the method consists of producing a recess 30 in the substrate 20, which consists of a flat stainless steel wafer. The upper surface 21 of the substrate 20 before machining is flat and corresponds to the plane P1 defined above. Conventional mechanical machining is used to produce the recess 30 in the form of two inclined planes meeting along the mid-line of the applique, thus forming a V-shaped cross-section. The recess depth d, measured at the mid-line of the applique, is 250 μm.

The second step E2 of the method consists of depositing an anti-reflective layer 25 on the substrate 20. The anti-reflective layer 25 has a thickness of 200 nanometers of a product known by its trade name AZ®-BARLi®. The anti-reflective layer 25 formed makes it possible to completely attenuate UV reflection on the substrate. It is also an electrical insulator.

The third step E3 is the step of forming the walls 41 of the mold from resin. It comprises a plurality of photolithography sub-steps, similar to those described above.

In this exemplary embodiment, the walls are positioned in line with the interface 4 of the recess 30, as shown in FIG. 22. Due to the positioning of the walls near an inclined surface 31, the presence of an anti-reflective layer 25 is strongly advised, for the satisfactory definition of the cross-linking of the photosensitive resin 40. The incident radiation 45 arriving on the interface 4 of the recess 30 can generate stray reflections, as explained above.

The fifth step E5 of the method consists of manufacturing the part by casting material, in particular known by its trade name HyCeram®, in order to fill the mold, and then heat-treating it to give it its final configuration. The result of this step E5 is shown in FIG. 23.

The sixth step E6 of the method consists of detaching the complex-shaped part from its mold. The resulting one-piece, integrally-formed applique comprises a beveled inclined surface having a mirror-polished surface finish resulting directly from the manufacturing method, and having dimensions and slopes corresponding strictly with the required geometry. It can be used directly following this demolding step E6, without post-processing, that is, without reworking or tribofinishing, of the surface obtained by contact with the substrate forming the base of the mold.

The opposite face 63 of the applique, which was not in contact with the mold, is polished to ensure that it is flat.

1. A method for manufacturing a mold for manufacturing a timepiece component, wherein the method comprises the following steps:
Producing (E1) a recess originating from an upper surface (21) of at least one substrate (20, 20′), so as to form a recess (30, 30′) delimited by at least one surface (31) inclined relative to the plane (P1) in which said upper surface (21) of the substrate (20, 20′) extends;
Producing at least one wall (41) of the mold (E3), this step comprising a sub-step consisting of depositing (E31) a material on at least part of the upper surface (21) of the substrate (20, 20′) and/or of the recess (30, 30′), optionally covered with a conductive layer (22) and/or an anti-reflective layer (25),
so as to form a mold at least partially delimited by at least one wall (41) of said material and by said at least one inclined surface (31) of the recess (30, 30′), and optionally by at least part of the upper surface (21) of the substrate (20, 20′).

2. The method for manufacturing a mold as claimed in the preceding claim, wherein the step (E3) consisting of producing at least one wall of the mold consists of depositing a resin (40) on part of the upper surface (21) of the substrate (20, 20′) and/or of the recess (30, 30′) comprises the following sub-steps:
Depositing (E31) a layer of photosensitive resin (40) on at least part of the upper surface (21) and/or of the recess (30, 30′) of the substrate (20, 20′);
Exposing (E32) said photosensitive resin (40) to exposing radiation (45) in a predefined pattern, in particular through a mask (5), then
Developing (E33) said resin (40).

3. The method for manufacturing a mold as claimed in claim 1 or 2, wherein the material or the resin (40) forms at least one wall (41) of the mold in line with the interface (4) between the upper surface (21) and said recess (30) of the substrate (20, 20′), and/or the material or the resin (40) forms at least one wall (41) of the mold inside said recess (30, 30′), and/or the material or the resin (40) forms at least one wall (41) of the mold outside said recess (30, 30′) on the upper surface (21) of the substrate.

4. The method for manufacturing a mold as claimed in one of the preceding claims, wherein the step consisting of producing (E1) a recess (30, 30′) forms said at least one inclined surface (31) having an inclination forming an angle of between 10 and 80 degrees relative to the upper surface (21) of the substrate (20, 20′), and in particular forms said at least one inclined surface (31) that is rounded or flat or formed by a multitude of facets or comprising at least one sharp edge and/or being concave or convex.

5. The method for manufacturing a mold as claimed in one of the preceding claims, wherein the step consisting of producing (E1) a recess (30, 30′) makes use of a two-photon polymerization, grey photolithography or stereolithography technique.

6. The method for manufacturing a mold as claimed in claim 2 or as claimed in one of claims 3 to 5 as dependent on claim 2, wherein the method comprises an intermediate step consisting of applying (E2) an anti-reflective treatment to the substrate (20, 20′), in particular depositing an anti-reflective layer (25) on the substrate (20, 20′), at least on part of the surfaces of the substrate (20, 20′) that are not perpendicular to the incident exposing radiation (45) intended to expose the resin, in particular on at least part of said at least one inclined surface (31) of the recess (30, 30′), before the step consisting of depositing (E31) a layer of photosensitive resin (40), in order to prevent the reflection of the exposing radiation (45) used to expose said photosensitive resin.

7. The method for manufacturing a mold as claimed in the preceding claim, wherein the intermediate step consisting of applying (E2) an anti-reflective treatment comprises depositing an anti-reflective layer (25) by spin coating, or spray coating, or dip coating, or chemical vapor deposition (CVD), or physical vapor deposition (PVD), or atomic layer deposition (ALD), or pulsed laser deposition (PLD).

8. The method for manufacturing a mold as claimed in one of claims 6 and 7, wherein the method comprises a step of partially or fully removing (E4) an anti-reflective layer (25) after the step consisting of developing (E33) said photosensitive resin with exposing radiation.

9. The method for manufacturing a mold as claimed in one of the preceding claims, wherein the substrate (20, 20′) is made from a conductive material, and in particular is in the form of a metal wafer, such as stainless steel, or the substrate is made from a non-conductive material, and in particular is in the form of a silicon, glass or ceramic wafer, or from polymer, or from composite, and optionally wherein the method comprises a step of depositing a metallic layer on the substrate made from a non-conductive material, including on the at least one inclined surface.

10. A method for manufacturing a timepiece component (1), wherein the method comprises a first phase corresponding to the method for manufacturing a mold as claimed in one of the preceding claims, and a second phase of forming the timepiece component (1) comprising a step consisting of filling (E5) all or part of said mold with a component material (10).

11. The method for manufacturing a timepiece component as claimed in the preceding claim, wherein the step consisting of filling (E5) the mold comprises a step of electrodeposition, electroforming, electroplating, slip casting, thermoforming, or a step of filling (E5) by casting the component material (10).

12. The method for manufacturing a timepiece component as claimed in claim 10 or 11, wherein the method comprises a step consisting of detaching (E6) from the mold the timepiece component (1) obtained in the step consisting of filling (E5) the mold, and optionally comprises a finishing step consisting of polishing or grinding the face (3) of the timepiece component (1) not in contact with the mold, in particular to ensure that it is flat, and/or consisting of changing the color or the tribological properties of at least part of the surface of the timepiece component by depositing a coating formed by a physical vapor deposition (PVD), or chemical vapor deposition (CVD), or atomic layer deposition (ALD), or pulsed laser deposition (PLD) method.

13.

14. The method for manufacturing a timepiece component as claimed in one of claims 10 to 12, wherein said component material (10) is a metal or a metal alloy, in particular nickel-, or gold-, or copper-based, or is ceramic-based, or is a composite material.

15. The method for manufacturing a timepiece component as claimed in one of claims 10 to 13, wherein the timepiece component (1) is an exterior timepiece component such an applique or a hand, or a component of the movement, such as an escapement wheel, or a lever, or a spring.

16. A mold for manufacturing a timepiece component, wherein the mold comprises a substrate (20, 20′) comprising an upper surface (21) and at least one recess (30, 30′) formed originating from this upper surface (21), said recess (30, 30′) comprising at least one surface (31) inclined relative to the plane (P1) in which said upper surface (21) of the substrate (20, 20′) extends, and the mold comprises a material such as a resin (40) deposited on at least part of the upper surface (21) of the substrate (20, 20′) and/or of the recess (30, 30′), forming at least part of at least one wall (41) of the mold, and said inclined surface (31) of said recess (30, 30′) of the substrate (20, 20′) at least partially forms the base of the mold.

17. The mold for manufacturing a timepiece component as claimed in the preceding claim, wherein the material such as resin (40) forms at least one wall (41) of the mold in line with the interface (4) of said recess (30, 30′) and of the upper surface (21) of the substrate (20, 20′), and/or the material such as resin (40) forms at least one wall (41) of the mold inside said recess (30, 30′), and/or the material such as resin (40) forms at least one wall (41) of the mold outside said recess (30, 30′) on the upper surface (21) of the substrate (20, 20′), and/or said at least one inclined surface (31) of the recess (30, 30′) of the substrate (20, 20′) has an inclination forming an angle of between 10 and 80 degrees relative to the upper surface (21) of the substrate (20, 20′), this angle being measured considering the upper surface (21) at the interface (4) between this upper surface (21) and the recess (30, 30′), in particular is rounded or formed by a multitude of facets, or comprises at least one sharp edge, and/or in particular is concave or convex.

18. A timepiece component obtained by the manufacturing method as claimed in one of claims 10 to 14, wherein the timepiece component is predominantly in one piece and comprises a first surface and a second surface inclined relative to this first surface, in particular domed and/or concave and/or convex, and/or faceted, and/or comprising at least one sharp edge.

19. The timepiece component as claimed in the preceding claim, wherein the timepiece component is predominantly made from a metal or a metal alloy, nickel-, or gold-, or copper-based, or the timepiece component is predominantly made from a ceramic or a composite material.

20. The timepiece component as claimed in one of claims 17 and 18, wherein the timepiece component is an exterior timepiece component such an applique or a hand, or a component of the movement, such as an escape wheel, or a lever, or a spring.

21. The timepiece component as claimed in one of claims 17 to 19, wherein the timepiece component comprises an aesthetic or functional insert.

22. The timepiece component as claimed in one of claims 17 to 20, wherein the timepiece component comprises at least one sharp edge and optionally polished or structured surfaces, in particular a surface comprising a “clou de Paris” pattern.
